(19) United States
(12) Patent Application Publication
(10) Pub. No.: US 2023/0054365 A1
(43) Pub. Date: Feb. 23, 2023

(54) SEPARATOR PLATE

(71) Applicant: Reinz-Dichtungs-GmbH, Neu-Ulm (DE)

(72) Inventors: Andre SPEIDEL, Neu-Ulm (DE); Thomas STOEHR, Neu-Ulm (DE); Bernadette GRUENWALD, Neu-Ulm (DE); Claudia KUNZ, Neu-Ulm (DE); Ahmet ORUC, Neu-Ulm (DE); Bernd GAUGLER, Neu-Ulm (DE); Rainer GLUECK, Neu-Ulm (DE)

(21) Appl. No.: 17/820,844

(22) Filed: Aug. 18, 2022

(30) Foreign Application Priority Data
Aug. 20, 2021 (DE) 202021104475.6

(51) Int. Cl. H01M 8/0258; H01M 8/0206; H01M 8/0276

(52) U.S. Cl. CPC H01M 8/0258; H01M 8/0206; H01M 8/0276

(57) ABSTRACT

A separator plate comprising a metal layer. The metal layer having at least one bead and the at least one bead having two bead flanks. At least one of the bead flanks having segments with different angles to the plane of the metal layer.

### CROSS-REFERENCE TO RELATED APPLICATION

The present application claims priority to German Utility Model Application No. 20 2021 104 475.6, entitled “SEPARATOR PLATE”, and filed on Aug. 20, 2021. The entire contents of the above-listed application is hereby incorporated by reference for all purposes.

### TECHNICAL FIELD

The present disclosure relates to a separator plate, such as a separator plate for an electrochemical cell. Such electrochemical cells are, for example, redox flow batteries, electrochemical compressors, fuel cells or electrolysers.

### BACKGROUND AND SUMMARY

In fuel cells, for example, a plurality of such separator plates are stacked in pairs perpendicular to the layer plane of the separator plate. The pairs of separator plates will hereinafter also be referred to as bipolar plates. The individual pairs of separator plates, for example the bipolar plates, are spaced apart from one another by means of intermediate layers, for example membranes or membrane electrode assemblies (MEAs).

A membrane electrode assembly (MEA) usually comprises an electrochemically active region, in which proton transfer takes place between the two sides of the MEA and in which electrodes and catalytic coatings are present on the membrane surfaces; outside of the electrochemically active region, the MEAs are usually encircled by a reinforcement edge. In addition, at least in the electrochemically active region, a gas diffusion layer is usually also present on every surface, which gas diffusion layers make it easier for oxygen and hydrogen to reach the coated membrane.

For the sake of simplification, in relation to the separator plates, the terms electrochemically active region and electrochemically inactive region will be used below even when referring to the regions situated opposite these regions of the MEA.

In order to delimit fluid-guiding spaces from one another and from the outside, these separator plates have a plurality of beads. Typically, beads in metal bipolar plates are formed as full beads. However, the balconies and, where applicable, the distribution channels may also be regarded as beads; in this regard, balconies have a cross-section in the manner of a half-bead while distribution channels have a cross-section in the manner of a full bead at least in some portions of their course.

In full beads, when viewed in cross-section transversely to the longitudinal extension of the bead as selected below, the bead protrudes furthest out of the material plane adjacent to the two sides of the bead by its bead top, which is generally arranged in the middle. Adjacent to this bead top on both sides are respective bead flanks, by which the camber of the bead top is led back to said material plane. In the region of each tangential transition into the material plane, there is a bead foot on the bead flank side facing away from the bead top.

When viewed in cross-section transversely to the longitudinal extension of the bead as selected below, half-beads form, in one layer, an offset from the layer plane (a gooseneck). The transition between the adjacent layer planes is referred to as a bead flank, which is adjoined on both sides by a respective bead foot. One of the bead feet may also be referred to as the bead top.

The beads in the separator plates may be sealing beads, which seal off in a fluid-tight manner the fluid-guiding spaces between separator plates and adjacent MEAs. For sealing beads, a distinction can be made between port beads, for example beads surrounding through-openings, and perimeter beads, for example sealing beads towards the outer edge. Beads are also used to create channel-like depressions or elevations in the separator plates, in which fluids are guided, for example reactants such as hydrogen or oxygen or air or also coolants.

Outside of the electrochemically active region, such channels may be used to guide fluids across sealing beads, so-called media passages or “tunnels”, so that these tunnels form intersections with the sealing beads. Hereinbelow, the term “intersection” is to be understood not as a crossing at right angles, but rather can also encompass a crossing at other angles.

Furthermore, beads or bead-like elevations can also be used as support elements, such as adjacent to the edge of the electrochemically active region. They may extend transversely to a sealing bead and serve to support the reinforcement edge of the MEA. The support elements may open into the flanks of the adjacent sealing bead, but they may also be spaced apart therefrom. Given a suitable height and width, the support elements that open into the flanks of the adjacent sealing bead are also used to prevent any ingress of media into the intermediate space between the electrochemically active region and the sealing bead. These support elements that open into the sealing bead will hereinafter also be regarded as fluid-guiding beads, even though the main task of these beads is to hold back fluid.

Depending on the course of the beads (sealing beads and/or channels) and on the proximity to or intersection with adjacent beads, these beads have along the course thereof regions that are more supple or more stiff while otherwise being of identical design. By way of example, sealing beads that extend in a wavy manner—for instance in plan view—have different stiffnesses in the region of the peaks or troughs of the wavy course than between peaks and troughs. As a result, the force-displacement characteristic of the bead varies along the course thereof, and the bead compression in the compressed/installed state of the separator plate is uneven along the course of the bead.

In the same way, beads are at least in part stiffer in regions where they intersect with media passages than at a distance from media passages. Media passages therefore usually lead to an uneven compression of the bead along its course. The same applies to regions where support elements, which are likewise regarded as fluid-guiding beads, open into the flanks of beads.

One disadvantage may be that, in the case of such uneven bead compression, the working distance of the bead as a whole is lower than in the case of even bead compression, thereby adversely affecting the sealing behaviour of the bead.

The object of the present disclosure is therefore to provide a separator plate in which the bead compression is influenced in a targeted manner, for example is made even.

This object is achieved by the separator plate according to claim 1 and according to claim 14. Advantageous developments of the separator plates according to the present disclosure can be found in the respective dependent claims.

The separator plate according to the present disclosure comprises a metal layer with at least one bead. The bead may be, for example, a sealing bead or a fluid-guiding bead, for example a media passage transverse to the sealing bead, a fluid channel immediately adjacent to a port, or a fluid channel immediately adjacent to a distribution or collection region of a separator plate. The present disclosure is applicable to any type of bead on a separator plate, for instance including half-beads or full beads.

According to the present disclosure, the bead in a first segment along the direction of extension of the bead has an inventive design of its flanks. In cross-section perpendicular to the bead course, one or both bead flanks of the bead in this first segment have at least a first, outer portion and a second, inner portion. These two portions have different positive angles to the plane of the metal layer adjacent to the bead, for example the flank has different gradients in the two portions.

According to the present disclosure, the first, outer portion and the second, inner portion described here are portions that are provided with the above-described positive angles in a targeted manner, for example portions the angle of which is predetermined by the moulding die as early as during the moulding process, e.g. during the embossing process. In other words, they are not transition regions that are automatically produced between different portions during any moulding process and have, in the direction of extension between the first portion and the second portion, significantly smaller extents (and therefore also small radii), for example in the region of 0.2 or 0.3 mm, than the first portion and the second portion, which usually have an extent of at least 0.35 mm or even of at least 0.45 mm in the case of the inner portion.

In the present disclosure, the first portion and the second portion advantageously merge into one another directly, possibly with merely a transition region therebetween that has been automatically produced during the moulding process. In this case, the bead flank in this segment may have precisely one first, outer portion and precisely one second, inner portion, for example the first, outer portion and the second, inner portion form the entire bead flank.

In the present disclosure, between the two sides adjacent to the first, outer portion and the second, inner portion there may be an uninterrupted upward gradient of the bead flank between the side of the two portions that is oriented towards the bead foot and the side of the two portions that is oriented towards the bead top, owing to the direct transition between the two portions. For instance, there is no recessing of the bead flank between the two portions.

For instance, if the first portion has an angle α and the second portion has an angle β, it is advantageous if the gradient of the first portion is smaller than the gradient of the second portion, for example α<β. This means that the bead flank, starting from the bead foot, first rises with a shallow gradient in a first portion and then rises more steeply in a second portion up to the bead top.

As a result, it is possible to make the bead in the first segment more supple and more elastic than when the bead flank extends with one predefined gradient from the bead foot to the bead top in the conventional manner. This makes it possible to make the bead in the first segment more supple and more elastic than in adjacent segments, and thus to match it to the force-displacement characteristic of the bead in the adjacent segments. For example, by virtue of the inventive design of the bead, the foot support of the bead, for example a foot support point, a foot support line or a foot support surface, can be suitably adjusted so as to influence the resulting force on the bead top. Overall, the present disclosure makes it possible for the compression of the bead to be made even along the extension of the bead, even when this is influenced or disrupted by external factors, such as for example adjacent beads, media passages, etc.

Advantageously, the first portion and/or the second portion extend in a rectilinear manner in cross-section through the bead perpendicular to the direction of extension of the bead.

A curved course is also possible. In this case, the curvature of the first and/or second portion differs significantly from the curvatures that are unavoidable for technical reasons and that have very small radii of curvature of less than 0.35 mm at the transition from the bead foot to the bead flank and at the transition from the bead flank to the bead top. For example, the first curved portion extends from the bead foot towards the bead top at an angle α that increases over the cross-section, for example the first portion is curved in the direction of the bead top. In cross-section, the curvature of the first portion advantageously takes place with a radius R1, advantageously where 0.5 mm≤R1, advantageously 2 mm≤R1, and/or R1≤70 mm, advantageously R1≤50 mm. If the first portion is provided with an upward gradient that increases in the direction of the bead top, this enables rolling off when compressed and released.

Another advantageous variant provides that the separator plate has at least two beads, the mutually facing bead flanks of which are designed according to the present disclosure as described above, at least in some regions, wherein the first portions of the flanks of the two beads merge into one another directly at least in some portions. By way of example, these may be a sealing bead and a fluid-guiding bead extending next to one another at least in some portions. A transition of this kind between two beads may be provided in one, some or all of the portions in which the two beads extend in a substantially parallel manner, and for example or solely in one, some or all of said portions in which the at least two beads extend in a substantially parallel manner. Therefore, only the lowest point between the two beads can be regarded as the “bead foot” of such a bead flank, in the described embodiment.

One advantageous embodiment may arise in connection with a targeted design of the bead top in the first segment. By way of example, the bead top of the bead may be rectilinear or curved in cross-section perpendicular to the direction of extension of the bead, advantageously may be curved away from the plane of extension of the metal layer.

If the bead extends in a wavy manner in its direction of extension, with at least one wave trough and at least one wave peak, conventional beads have a different stiffness in the region of their wave troughs and their wave peaks than between the wave troughs and wave peaks. In this case, this can be compensated in that a first segment as defined above is formed in a wave trough and/or a wave peak. By way of example, a wave peak or a wave trough can be regarded as the area between the closest turning points of the wavy course of the bead.

If two adjacent regions of a bead with different stiffnesses are located one behind the other in the course of the bead, the force-displacement characteristic and the compression of the bead can be made even in that, in cross-section perpendicular to the bead course, in the region that without further measures would be the stiffer region as the second segment, one or both bead flanks of the bead extends at an angle γ to the plane of the metal layer adjacent to the sealing bead, this angle being greater than the angle δ to the plane of the metal layer of the bead flanks in the bead course adjacent to the second segment, for example in the region that without further measures would be more supple. This design of the bead flank can be used in addition to the preceding inventive design of the bead flank in the first segment, or also independently thereof, such as on a different bead of a separator plate according to the present disclosure.

Another possibility for reducing the stiffness of the bead in one region in a targeted manner arises if in this region as a third segment one or both bead flanks of the bead are designed in such a way that the distance between the bead feet of the bead is greater than the distance between the bead feet of the bead in the bead course adjacent to this third segment. By widening the bead at its base, the bead in this third segment becomes more supple and more elastic.

The present disclosure may be applied with advantage in the case of separator plates that have a sealing bead, such as a port bead, which is in contract, and may be intersected, by other beads, such as fluid passages. Such fluid passages (“tunnels”) may be found on sealing beads which surround fluid through-openings in the separator plate and seal these off with respect to the outside or with respect to other fluid spaces. For instance, such tunnels are often arranged in regions between a wave trough and a wave peak of a sealing bead that extends in a wavy manner in the direction of extension. At least at one side, these tunnels open into one of the flanks of the sealing bead. This may also apply to support elements which open into the flanks of the adjacent sealing bead, such as the flanks of a perimeter bead, said support elements likewise being regarded as fluid-guiding beads. The tunnels on the two flanks of the sealing beads may also be offset from one another in relation to the direction of extension of the bead and thus may be arranged, for example, only at bead maxima. The number of tunnels on the two flanks may also vary from one another. Such tunnels or support elements lead to a partial stiffening of the sealing bead in these regions, which can be compensated by an inventive design of the regions of the bead flank of the sealing bead that are adjacent to the tunnel or support element. For instance, however, one or both bead flanks of the bead-like fluid passage may be designed according to the present disclosure, and can thus counteract the stiffening of the sealing bead by the fluid passages. Compensation can also be achieved by designing the second flank of the bead in the manner according to the present disclosure if the tunnel or support element opens onto the first flank of the bead.

An alternative or additional inventive solution to the problem described above comprises that a metal layer of the separator plate has a bead (hereinafter referred to as the “second bead” in order to differentiate it from the solution mentioned above). This second bead may once again be a sealing bead or a fluid-guiding bead, for example for guiding a fluid through a sealing bead, or a channel for guiding a fluid. In one segment (hereinafter referred to as the “fourth segment” for differentiation purposes) along the direction of extension of the second bead, in one or both bead flanks of the second bead, this second bead is designed in such a way that the bead foot of the second bead is spaced apart from the bead top of the second bead, in a direction perpendicular to the layer plane of the metal layer, by a distance which is greater in the middle of the second segment than at the edges of the second segment. Since the height of the bead increases along the segment to the middle of the segment and then decreases again to the opposite end of the segment, the bead is more supple and more elastic in the middle of the segment. This makes it possible to change the force-displacement characteristic of the second bead in this region in a targeted manner and thus, for example, to achieve an even compression of the bead along the direction of extension of the bead. The increase in height of the bead is advantageously effected not by increasing the height of the bead top, but rather by lowering the bead foot in the non-compressed state of the separator plate. Advantageously, the lowest point of the bead foot is not lower than the lowest point of the bead feet in other segments.

Such a design of the second segment may be achieved in that, in cross-section perpendicular to the bead course, one or both bead flanks of the second bead have a length that increases from the edges of the second segment to the middle of the second segment.

In this solution according to the present disclosure, the gradient of the bead flank in the second segment may be constant along the direction of extension of the second bead. It is also possible, but not necessary, to provide, in the cross-section of the second bead in the region of the second segment, two portions of the bead flank with different angles of ascent.

The last-mentioned solution can advantageously be combined with the solution specified first, such as in the case of separator plates comprising a metal layer with one sealing bead and two adjacent bead-like fluid passages, in which the two adjacent bead-like fluid passages open into the flank of the sealing bead at adjacent points. In the case of such a separator plate, at least the mutually facing flanks of the bead-like fluid passages are designed as described above for the first segment, and the region of the bead flank of the sealing bead between the mouths of the bead-like fluid passages in the sealing bead are designed as described above for the second segment; in this case, the mutually facing flanks of the bead-like fluid passages form the edges of the second segment.

A few examples of separator plates according to the present disclosure will be given below. Identical or similar reference signs denote identical or similar elements, and therefore, where applicable, the description of these elements and reference signs will not be repeated. Each of the following examples implements a variety of optional features in addition to the mandatory features of the present disclosure. However, all the non-mandatory features not specified in the independent claims can also be combined, individually or in any combination, with other non-mandatory features of the same example or of one or more other examples.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a fuel cell according to the present disclosure.

FIG. 2 shows a bipolar plate of the fuel cell of FIG. 1.

FIG. 3A and FIG. 3B show details around fluid through-openings of a separator plate of the bipolar plate of FIG. 2.

FIG. 4 shows a detail of a separator plate of the bipolar plate of FIG. 2 in the region of an outer edge and a perimeter bead.

FIGS. 5A to 11C show, in plan view or in cross-section, details of separator plates according to the present disclosure.

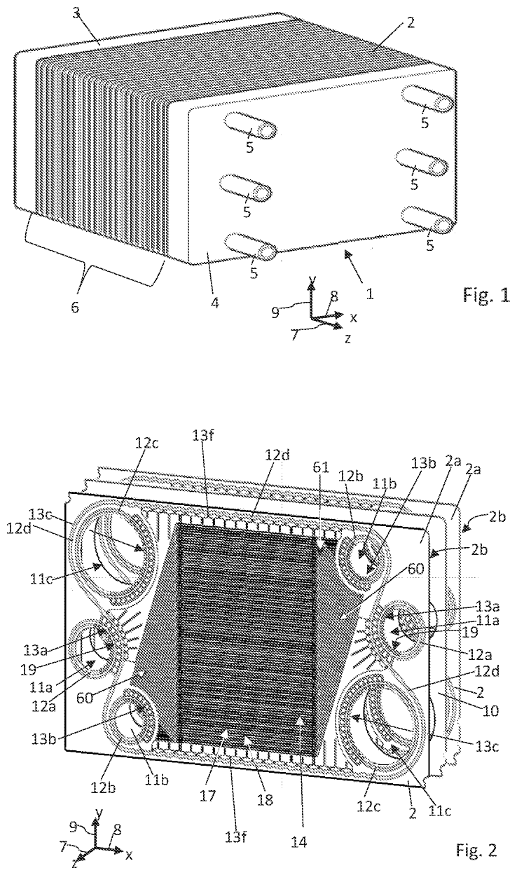

FIGS. 1-11C are shown approximately to scale.

### DETAILED DESCRIPTION

FIG. 1 shows an electrochemical system 1 comprising a plurality of structurally identical metal bipolar plates 2, which are arranged in a stack 6 and are stacked along a z-direction 7. The bipolar plates 2 of the stack 6 are clamped between two end plates 3, 4. The z-direction 7 will also be referred to as the stacking direction. In the present example, the system 1 is a fuel cell stack. Each two adjacent bipolar plates 2 of the stack therefore bound an electrochemical cell, which serves for example to convert chemical energy into electrical energy. To form the electrochemical cells of the system 1, a membrane electrode assembly (MEA) 10 is arranged in each case between adjacent bipolar plates 2 of the stack (see for example FIG. 2). Each MEA 10 contains at least one membrane, for example an electrolyte membrane. Furthermore, a gas diffusion layer (GDL) may be arranged on one or both surfaces of the MEA.

In alternative embodiments, the system 1 may also be designed as an electrolyser, as an electrochemical compressor or as a redox flow battery. Bipolar plates can likewise be used in these electrochemical systems. The structure of these bipolar plates may then correspond to the structure of the bipolar plates 2 explained in detail here, although the media guided on and/or through the bipolar plates in the case of an electrolyser, an electrochemical compressor or a redox flow battery may differ in each case from the media used for a fuel cell system.

The z-axis 7, together with an x-axis 8 and a y-axis 9, spans a right-handed Cartesian coordinate system. The bipolar plates 2 each define a plate plane, wherein the plate planes of the separator plates are each oriented parallel to the x-y plane and thus perpendicular to the stacking direction or to the z-axis 7. The end plate 4 usually has a plurality of media ports 5, via which media can be fed to the system 1 and via which media can be discharged from the system 1. Said media that can be fed to the system 1 and discharged from the system 1 may comprise for example fuels such as molecular hydrogen or methanol, reaction gases such as air or oxygen, reaction products such as water vapour or depleted fuels, or coolants such as water and/or glycol.

FIG. 2 shows, in a perspective view, two adjacent bipolar plates 2 of an electrochemical system of the same type as the system 1 from FIG. 1, as well as a membrane electrode assembly (MEA) 10, which is arranged between these adjacent bipolar plates 2, the MEA 10 in FIG. 2 being largely obscured by the bipolar plate 2 facing towards the viewer. The bipolar plate 2 of the described embodiment is formed of two separator plates 2a, 2b which are joined together in a materially bonded manner, of which in each case only the first separator plate 2a facing towards the viewer is visible in FIG. 2, said first separator plate obscuring the second separator plate 2b. The separator plates 2a, 2b each comprise at least one metal layer, for example formed of a stainless steel sheet. Two adjacent separator plates 2a, 2b may for example be welded to one another, e.g. by laser welds.

The separator plates 2a, 2b typically have through-openings which are aligned with one another and form through-openings 11a-c of the bipolar plate 2. When a plurality of bipolar plates of the same type as the bipolar plate 2 are stacked, the through-openings 11a-c form lines which extend through the stack 6 in the stacking direction 7 (see FIG. 1). Typically, each of the lines formed by the through-openings 11a-c is fluidically connected to one of the ports 5 in the end plate 4 of the system 1. For example, coolant can be introduced into the stack 6 or discharged from the stack via the lines formed by the through-openings 11a. In contrast, the lines formed by the through-openings 11b, 11c may be designed to supply fuel and reaction gas to the electrochemical cells of the fuel cell stack 6 of the system 1 and to discharge the reaction products from the stack. The media-guiding through-openings 11a-c are formed substantially parallel to the plate plane.

In order to seal off the through-openings 11a-c with respect to the interior of the stack 6 and with respect to the surrounding environment, the first separator plates 2a each have sealing arrangements in the form of sealing beads 12a-c, which are respectively arranged around the through-openings 11a-c and in each case completely surround the through-openings 11a-c. These sealing beads 12a-c that surround through-openings will also be referred to as port beads. On the rear side of the bipolar plates 2, facing away from the viewer of FIG. 2, the second separator plates 2b have corresponding sealing beads for sealing off the through-openings 11a-c (not shown).

In an electrochemically active region 18, the first separator plates 2a have, on the front side thereof facing towards the viewer of FIG. 2, a flow field 17 with first structures 14 for guiding a reaction medium along the outer side (or also front side) of the separator plate 2a. In FIG. 2, these first structures 14 are defined by a plurality of webs and by grooves extending between the webs and delimited by the webs. On the front side of the bipolar plates 2, facing towards the viewer of FIG. 2, the first separator plates 2a additionally each have a distribution or collection region 60. The distribution or collection region 60 comprises structures 61 which are designed to distribute over the active region 18 a medium that is introduced into the distribution or collection region 60 from a first of the two through-openings 11b, and/or to collect or to pool a medium flowing towards the second of the through-openings 11b from the active region 18. In FIG. 2, the distributing structures 61 of the distribution or collection region 60 are likewise defined by webs and by grooves extending between the webs and delimited by the webs.

The sealing beads 12a-12c have passages 13a-13c, of which the passages 13a are formed both on the underside of the upper separator plate 2a and on the upper side of the lower separator plate 2b, while the passages 13b are formed in the upper separator plate 2a and the passages 13c are formed in the lower separator plate 2b. By way of example, the passages 13a enable coolant to pass between the through-opening 12a and the distribution or collection region 60, so that the coolant enters the distribution or collection region 60 between the separator plates 2a, 2b and is guided out therefrom.

Furthermore, the passages 13b enable hydrogen to pass between the through-opening 12b and the distribution or collection region on the upper side of the upper separator plate 2a; these passages 13b are characterized by perforations facing towards the distribution or collection region and extending at an angle to the plate plane. By way of example, hydrogen thus flows through the passages 13b from the through-opening 12b to the distribution or collection region on the upper side of the upper separator plate 2a, or in the opposite direction. The passages 13c enable air, for example, to pass between the through-opening 12c and the distribution or collection region, so that air enters the distribution or collection region on the underside of the lower separator plate 2b and is guided out therefrom. The associated perforations are not visible here.

The first separator plates 2a each also have a further sealing arrangement in the form of a perimeter bead 12d, which extends around the flow field 17 of the active region 18 and also around the distribution or collection region 60 and the through-openings 11b, 11c and seals these off with respect to the through-openings 11a, that is to say with respect to the coolant circuit, and with respect to the environment surrounding the system 1. The second separator plates 2b each comprise corresponding perimeter beads 12d.

Both on the upper and on the lower outer edge, the first separator plates and also the second separator plates (not shown) have support elements 13f adjacent to the perimeter bead 12d and opening into the latter, which in their entirety prevent the fluids on the surfaces of the respective separator plate 2a, 2b that face towards the MEA from flowing into the intermediate space between the perimeter bead 12d and the structures 14, 61 for guiding a reaction medium.

The structures of the active region 18, the distributing or collecting structures of the distribution or collection region 60, the sealing beads 12a-d, the passages 13a-c and the support structures 13f are each formed in one piece with or in the separator plates 2a and are integrally formed in the separator plates 2a, for example in an embossing, hydroforming or deep-drawing process. The same applies to the corresponding structures of the second separator plates 2b. Each sealing bead 12a-12d may have in cross-section at least one bead top and two bead flanks, but a substantially angular arrangement between these elements is not necessary; a curved transition may also be provided.

While the sealing beads 12a-12c have a substantially round course, the perimeter bead 12d has various portions of different shapes. For instance, the course of the perimeter bead 12d may comprise at least two wavy portions. If, unlike in the present example, the port beads 12a-12c are not circular, these, too, may have a wavy course at least in some portions.

The two through-openings 11b or the lines through the plate stack of the system 1 that are formed by the through-openings 11b are each fluidically connected to one another via passages 13b in the sealing beads 12b, via the distributing structures of the distribution or collection region 60 and via the flow field 17 in the active region 18 of the first separator plates 2a facing towards the viewer of FIG. 2. Analogously, the two through-openings 11c or the lines through the plate stack of the system 1 that are formed by the through-openings 11c are each fluidically connected to one another via corresponding bead passages, via corresponding distributing structures and via a corresponding flow field on an outer side of the second separator plates 2b facing away from the viewer of FIG. 2. To this end, first structures, such as groove structures, 14 for guiding the relevant media are provided in the active regions 18.

In contrast, the through-openings 11a or the lines through the plate stack of the system 1 that are formed by the through-openings 11a are each fluidically connected to one another via a cavity 19 which is surrounded or enclosed by the separator plates 2a, 2b. This cavity 19 serves in each case to guide a coolant through the bipolar plate 2, for example for cooling the electrochemically active region 18 of the bipolar plate 2. The coolant thus serves primarily to cool the electrochemically active region 18 of the bipolar plate 2. The coolant flows through the cavity 19 from an inlet opening 11a towards an outlet opening 11d. Mixtures of water and antifreeze are often used as coolants. However, other coolants are also conceivable. For increased guidance of the coolant or cooling medium, second structures are present on the inner side of the bipolar plate 2. Said second structures are not visible in FIG. 2 since they extend, for example, on the surface of the separator plate 2a facing away from the viewer; they are therefore situated opposite the above-mentioned first structures 14 on the other surface of the separator plate 2a. In the active region 18, the second structures 15 guide the cooling medium along the inner side of the bipolar plate towards the outlet opening 11d. The second structures typically comprise groove structures for guiding the cooling fluid, which define a longitudinal flow direction of the cooling medium.

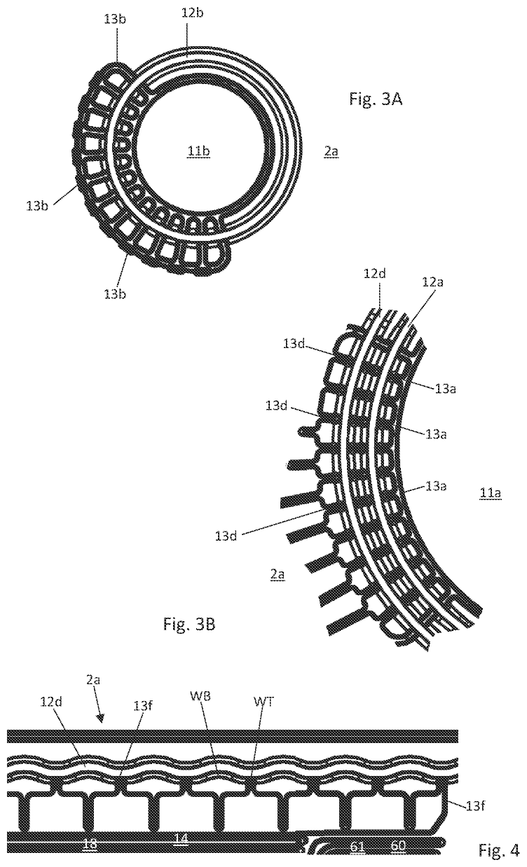

FIG. 3A shows, in plan view, a detail of the separator plate 2a in the region of the through-opening 11b of the separator plate 2a in FIG. 2. The through-opening through the separator plate 2a is completely surrounded by the sealing bead 12b. This sealing bead of the described embodiment is penetrated by bead-like media passages (“tunnels”) 13b, only a few of which are provided with the reference sign. The tunnels 13b enable the medium located in the through-opening 11b, here H₂ for example, to pass through the sealing bead 12b.

FIG. 3B shows, in plan view, a detail of the separator plate 2a in the region of the through-opening 11a of the separator plate 2a in FIG. 2. The through-opening through the separator plate 2a is completely surrounded by the port bead 12a and partially surrounded by the perimeter bead 12d. These sealing beads 12a and 12d of the described embodiment are penetrated by bead-like media passages (“tunnels”) 13a, and in the extension thereof 13d, only a few of which are provided with the reference sign. The tunnels 13a, 13d enable the medium located in the through-opening 11d, here coolant for example, to pass through the sealing bead 12a and the perimeter bead 12d.

FIG. 4 shows, in plan view, a detail of the separator plate 2a in the region of the outer edge and a perimeter bead 12d extending along this outer edge. The perimeter bead 12d is spaced apart from the structures 14, 61 closest thereto for guiding a reaction medium, thereby forming an intermediate space. To prevent reaction medium from flowing into this intermediate space, bead-like elevations 13f of the described embodiment are formed in the separator plate 2a, only a few of which are provided with the reference sign. The bead-like elevations may also serve as support elements for the MEA. The bead-like elevations 13f open into the flank of the perimeter bead 12d that faces towards the active region 18 and the distribution and collection region 60, and like the aforementioned tunnels 13a-d will be regarded as fluid-guiding beads in the context of this document.

Without additional measures, the sealing beads 12b and 12a would each have a different stiffness at the point of passage of the bead-like media passages in FIG. 3A and FIG. 3B than outside of these regions. The sealing beads 12b and 12a would thus be unevenly compressed along their extension in the plane of the separator plate 2b. However, this uneven compression is mitigated or eliminated by the specific design according to the following figures.

Since the following embodiments of the present disclosure can be applied to each of the through-openings of the bipolar plate 1 or one or both of its separator plates 2a, 2b and the environs thereof, in the following figures the through-opening through a separator plate will be denoted by reference sign 11, a sealing bead surrounding said through-opening will be denoted by reference sign 12, and the media passages through the sealing bead 12 will be denoted by reference sign 13. Channels for conveying a fluid, which directly connect to the media passages 13, will be denoted by reference sign 50. If a number of these elements occur, they will be provided with reference signs followed by one prime symbol, two prime symbols, etc. In relation to the channels 50, reference signs without any prime symbol, for example 50, relate to channels for the connection between the media passage 13 and the active region 18 whereas reference signs followed by a single prime symbol, for example 50′, relate to channels for the connection between the media passage 13 and ports 11 or the surroundings of the ports 11. Said ports are often also regarded as balconies.

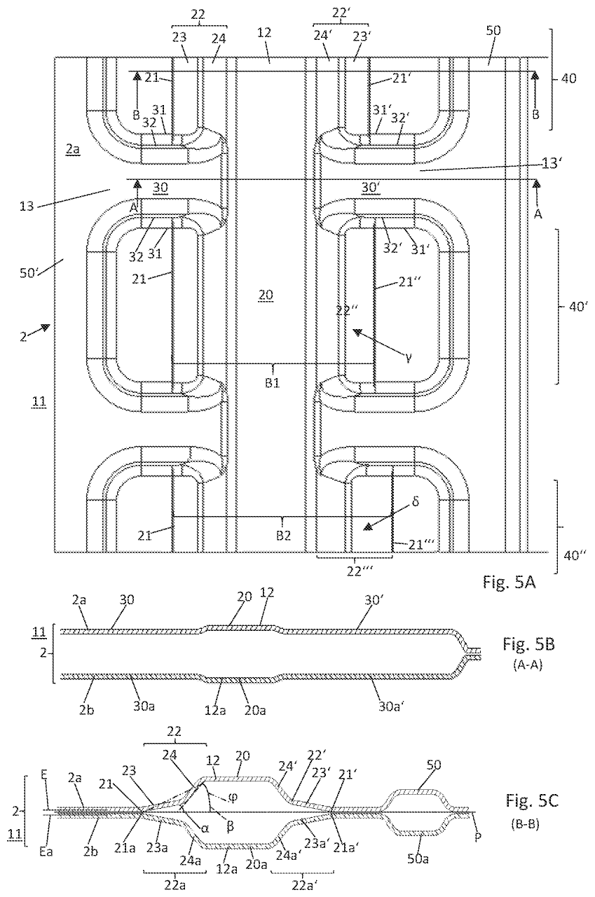

FIG. 5A shows, in plan view, a detail around an embodiment of sealing bead 12 of a bipolar plate 2 according to the present disclosure, which comprises two separator plates 2a, 2b which are joined together in a materially bonded manner, of which only the first separator plate 2a facing towards the viewer is visible in the plan view of FIG. 5A, said first separator plate obscuring the second separator plate 2b. The bipolar plate 2 and the separator plate 2a are shown in the non-compressed state, as per the illustrations in FIGS. 2 to 4. In the separator plate 2a, the sealing bead 12 has a bead top 20, bead feet 21, 21′, 21″, 21′″ on both sides, and bead flanks 22, 22′, 22″,22″. Arranged on both sides of the sealing bead 12 are bead-like fluid passages 30, 30′ (in an embodiment only these two fluid passages are provided with reference signs), which open into the bead flanks 22, 22′ or, in the case of the fluid passage 30′, pass between the bead flank portions 22′, 22″. These fluid passages 30, 30′ in turn have bead feet 31, 31′ and bead flanks 32, 32′. On their side remote from the sealing bead, the fluid passages 30, 30′ open into distribution channels 50 (towards the active region 18) and 50′ (towards the ports 11), which may in turn also be regarded as beads.

FIG. 5B shows a section through the bipolar plate 2 along the line A-A in FIG. 5A in a region in which the fluid passages 30, 30′ are arranged. The two separator plates 2a and 2b are formed in mirror symmetry in relation to the plane of contact (at the right-hand edge of the drawing) between the two separator plates 2a and 2b, at least in the detail shown. In the separator plate 2a, the tops of the fluid passages 30, 30′ are lower than the bead top 20 of the bead 12. Equally, in the separator plate 2b, the tops of the fluid passages 30a, 30a′ are lower than the bead top 20a of the bead 12a. The flow resistance of the fluid passages may be adjusted by way of the height and width of the fluid passages 30, 30a, 30, 30a′.

FIG. 5C shows a section through the bipolar plate 2 along the line B-B in FIG. 5A in a region of a segment 40 along the direction of extension of the sealing bead 12. At least in the detail shown, the two separator plates 2a and 2b are formed in mirror symmetry in relation to the plane of contact P between the two separator plates 2a and 2b. The lines E and Ea denote the neutral fibre of the metal sheet of the separator plates 2a and 2b in a region in which the separator plates 2a and 2b are in contact in the plane of contact P. All the details regarding the course of the separator plates, for example angles, are details that may relate to the course of the neutral fibre of the separator plates 2a and 2b.

In addition to a substantially flat bead top, the bead 12 has bead flanks 22, 22′ on both sides, which have a first, outer portion 23, 23′ and a second, inner portion 24, 24′, the first, outer portions 23, 23′ and the second, inner portions 24, 24′ of the same bead flank merging into one another directly, for example without the intentional or targeted provision of any interjacent portion. Transition regions between the first, outer portion and the second, inner portion may arise solely as a result of technical requirements, e.g. as a transitional curve between the two portions, which extend with different steepnesses.

For instance, arranging the first, outer portion and the second, inner portion one behind the other results in a continuous upward gradient of the bead flank from one side of the two portions to the other side of the two portions, such as without any recessing between the two portions.

The first, outer portions 23, 23′ have a smaller gradient a than the second, inner portions 24, 24′. One leg of the angle β in the inner portion 24 is spanned by the elongated dashed line in the extension of the inner portion 24. In summary, this results in an angle ϕ for the bead flank 22 as a whole; here, the upper leg is spanned by the elongated double-dashed line. By virtue of this design of the bead flanks 22, 22′, the sealing bead is more supple and more elastic in the region of the first segment 40 than in the region where the fluid passages 30, 30′ open into the bead flanks 22, 22′. Overall, a uniform stiffness of the sealing bead 12 can thus be achieved even in the region of the fluid passages 30, 30′. In the example of FIGS. 5A-C, the bead top is rectilinear and flat, as can be seen from FIG. 5C.

The detail shown in FIG. 5A shows three segments 40, 40′, 40″ at least in the detail. The bead flanks 22′, 22″, 22′″ situated on the right have a different width, as can also be seen on the bead foot 21′, 21″, 21′″ of different width that is shifted to the right. In contrast, the bead flanks 22 situated on the left have the same width in all three segments 40, 40′, 40″; all the bead feet 21 are situated on the same straight line. Consequently, the distance between the bead feet 21 and 21′″ of the bead in the third segment 40″ is greater than the distance between the bead feet 21, 21″ of the bead in the bead course adjacent to the third segment 40″, namely in the second segment 40′. In cross-section perpendicular to the bead course, the bead flank 22″ of the bead 12 in the second segment 40′ extends at an angle γ to the plane of the metal layer adjacent to the sealing bead 12, the angle γ being greater than the angle δ of the bead flank 22′″ to the plane of the metal layer 2a in the bead course in the third segment 40″, for example adjacent to the second segment 40′. The angles γ and δ are summary angles of the entire bead flank, comparable to the angle ϕ in FIG. 5C.

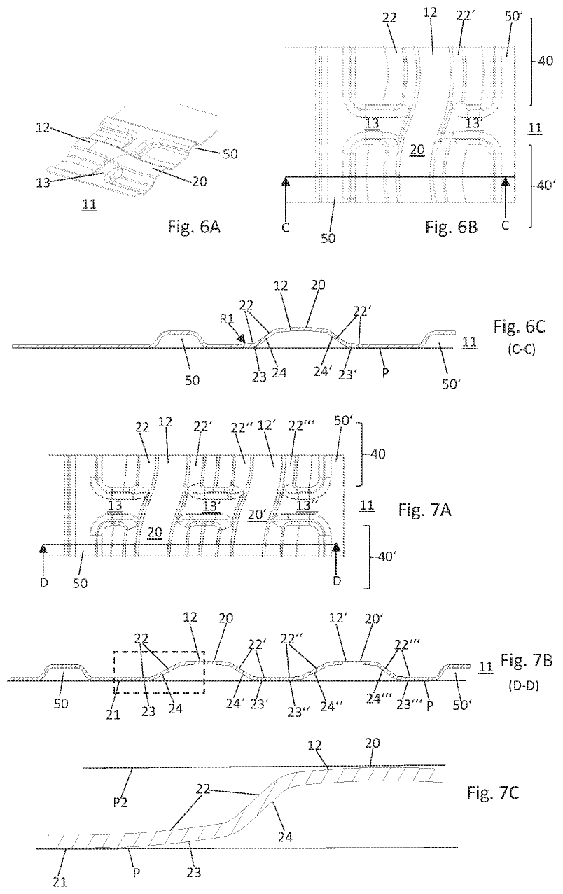

FIG. 6A shows, in an oblique view, a detail of another inventive design of the sealing bead 12 of a separator plate according to FIGS. 1 to 4. FIG. 6B shows the same region in plan view, and FIG. 6C shows a section along the line C-C in the segment 40 in FIG. 6B.

In a manner differing from FIGS. 5A-C, the first portion 23, 23′ of the bead flanks 22, 22′ is now no longer rectilinear in cross-section, but instead is rounded with a predetermined radius R1. This design, too, makes it possible to configure the elasticity of the sealing bead 12 in a targeted manner in the segment 40, such as to increase it.

FIG. 7A shows, in plan view, a detail of another inventive design of the sealing bead 12. FIG. 7B shows a cross-section along the line D-D in FIG. 7A, and FIG. 7C shows an enlarged representation (not to scale) of the detail framed by the dashed line in FIG. 7B. Here, two beads 12, 12′ extend at a distance from one another in a substantially parallel manner, and the first portions 23′, 23″ of the mutually facing flanks 22′, 22″ of the two beads 12, 12′ merge into one another. In this design, too, the first portion 23 of the bead flank 22 is rounded, wherein in cross-section the radius of the rounding increases from the bead foot to the second portion. As in the previous designs, the second portion is rectilinear in cross-section. It is clear from the detail view in FIG. 7C that the bead top in this example is curved. The plane P2 of the bead top can in such a case be defined as a plane which extends through the highest point of the bead top and which is parallel to the plane P of the metal layer of the separator plate 2a. In a first approach, parallelism between two beads, here the beads 12, 12′, can be regarded as parallelism of the local direction of extension of the respective bead. In a second approach, however, it can also be regarded as parallelism of the macroscopic bead direction. In this second approach, the beads 12, 12′ extend parallel to the distribution channels 50 and 50′, the latter of which extends around the port 11 in a balcony-like manner.

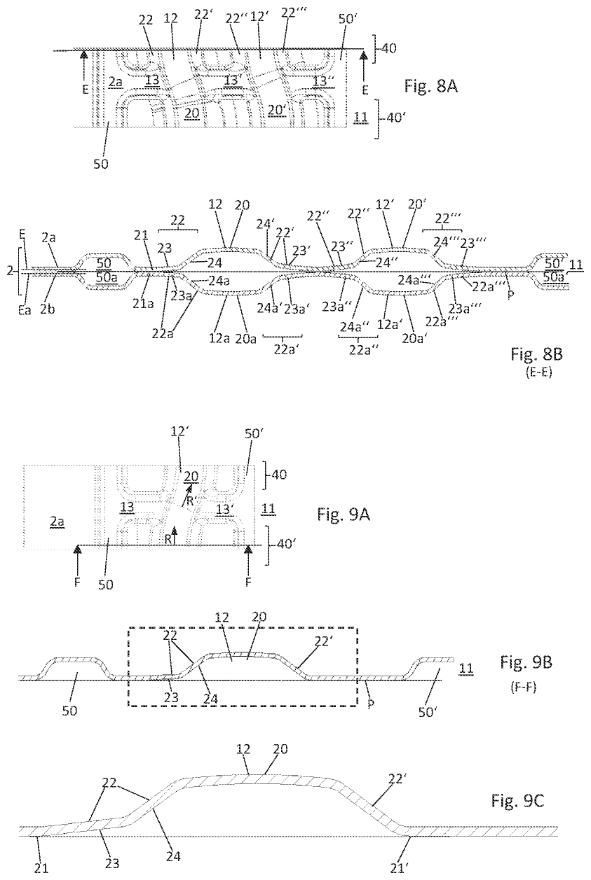

FIG. 8A shows, in plan view, a detail of another embodiment of bipolar plate 2 comprising two separator plates, although only the separator plate 2a facing towards the viewer is visible.

FIG. 8B shows a cross-section through the bipolar plate 2 along the line E-E in a segment 40 in FIG. 8A. At least in the detail shown, the two separator plates 2a and 2b are formed in mirror symmetry in relation to their plane of contact between the two separator plates 2a and 2b. For this reason, only the separator plate 2a will be described in detail below.

In this design, which in principle is like the one in FIGS. 7A-C, two sealing beads 12, 12′ are provided, which in the detail shown extend in a parallel manner. The sealing beads 12, 12′ extend in a wavy manner in the direction of extension. Arranged in the region between a wave peak and a wave trough, such as in the region of the turning point, are fluid passages 13, 13′, 13″, by means of which a fluid can flow across the sealing beads 12, 12′. By way of example, the sealing bead 12 may be a perimeter bead as in FIG. 2, and the sealing bead 12′ may be a sealing bead around a through-opening as in FIG. 2.

In the segment 40, for example between or adjacent to fluid passages 13, 13′, 13″, the bead flanks of the adjacent sealing beads 12, 12′ are designed in such a way that the first portions of the bead flanks 22′, 22″, which are arranged facing one another, merge into one another. The first portions 23, 23′, 23″, 23′″ of the bead flanks 22, 22′, 22″, 22′″ are in each case curved in cross-section, while the second portions 24, 24′, 24″, 24′″ of the bead flanks 22, 22′, 22″, 22′″ are in each case rectilinear in cross-section.

FIG. 9A shows, in plan view, a detail of another inventive separator plate 2a comprising a sealing bead 12, which has a wavy course in the direction of extension (arrows R, R′). Based on the arrows R, R′, it is clear from FIG. 9A that the direction of extension of the bead 12 is a local direction of extension, which varies along a wavy bead. FIG. 9B shows a cross-section along the line F-F in FIG. 9A, and FIG. 9C shows an enlarged representation (not to scale) of the detail framed by the dashed line in FIG. 9B. The design in the embodiment of FIGS. 9A-C is like the one in FIGS. 6A-C, but only the bead flank 22 has a first portion 23 that is rectilinear in cross-section and a second portion 24 that is rectilinear in cross-section. The second bead flank 22′ has one continuous gradient.

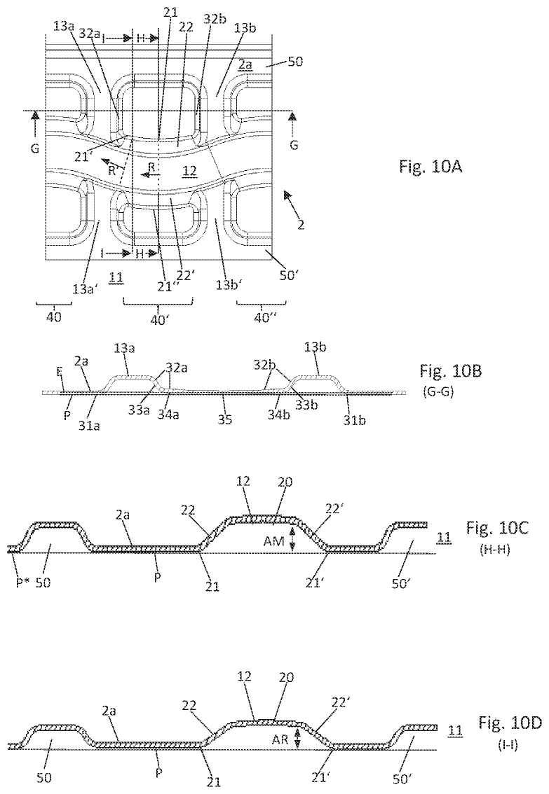

FIG. 10A shows, in plain view, a detail of another inventive bipolar plate 2 comprising a sealing bead 12, although now with bead-like fluid passages 13a and 13b. This largely corresponds to the design of the sealing beads 12, 12′ in FIGS. 8A-B. Here, too, the bead flanks 32a, 32b in a segment 40′ have second portions 33a, 33b and first portions 34a, 34b, the latter being curved and merging into one another. The lowest point 35 is located at the point of transition between the first two portions 34a and 34b. The segment 40′ is delimited in each case by bead-like elevations 13a, 13b, namely passage tunnels.

In FIG. 10A, the plane of contact with a second separator plate (not shown) that is in mirror symmetry at least in the detail shown is marked as the plane P for the separator plate 2a. The marked plane E denotes the course of the neutral fibre in the separator plate 2a in the non-beaded regions, for example in the regions in which the separator plate 2a is in contact with the adjacent, mirror-symmetrical separator plate in the plane of contact P.

FIG. 10A shows a plan view, FIG. 10B shows a section along the line G-G in FIG. 10A, FIG. 10C shows a section along the line H-H in FIG. 10A, and FIG. 10D shows a section along the line I-I in FIG. 10A.

FIGS. 10C and 10D may show the design of the sealing bead 12 and of the flanks 22, 22′ thereof in a segment 40′ in a central region of the segment 40′ and in a region of the segment 40′ adjacent to the fluid passages 13a and 13b.

The bead flanks 22 and 22′ are longer in the region of the section line H-H and extend further towards the bead bottom 21, 21′ than in the region I-I, AM>AR. This also achieves the effect according to the present disclosure. For instance, in this embodiment, the fluid passages 13a and 13b in the region 40 are designed in accordance with one solution according to the present disclosure and the sealing bead 12 in the region 40′ is designed in accordance with the other solution according to the present disclosure. The length and/or the distance is determined in each case perpendicular to the local bead course direction R, for example along the dashed lines in FIG. 10A.

If the region between the bead flanks touches the plane P of the metal layer of an embodiment of separator plate 2a only in very limited areas, this plane can also be determined in other regions of the plate, for example adjacent to the bead, as shown using the example P*.

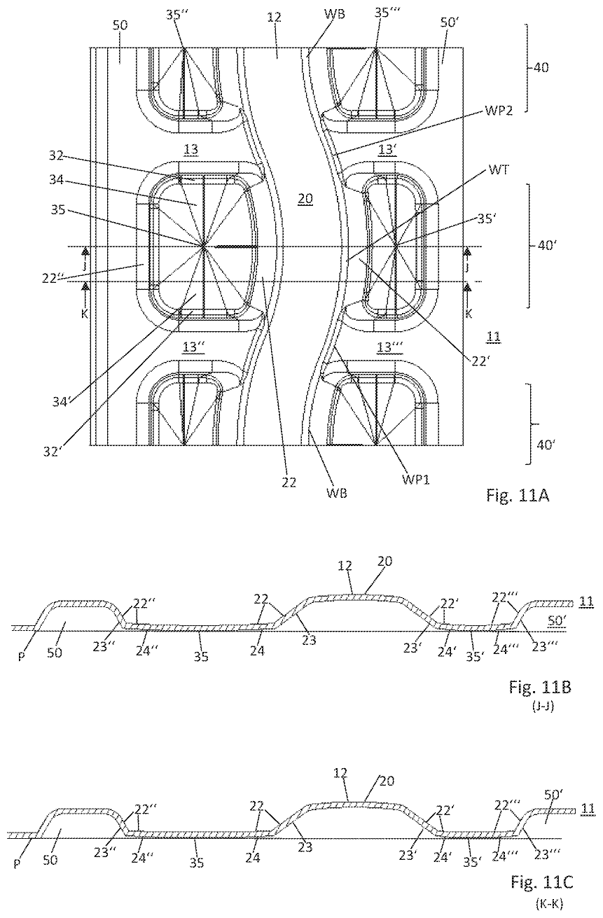

FIG. 11A shows a plan view, FIG. 11B shows a section along the line J-J in FIG. 11A, and FIG. 11C shows a section along the line K-K in FIG. 11A. In this embodiment, the outer portions 24, 24′ of the bead flanks 22, 22′, 22″ and the outer portions 34, 34′ of the bead flanks 32, 32′ are both formed with a radius leading to the lowest point 35. The entirety of the outer portions 24, 24′, 34, 34′ is therefore spherical. The first segment 40 and the third segment 40″ are arranged in the region of a wave peak WB; the second segment 40′ is situated in the region of a wave trough WT, more specifically between the two turning points WP1 and WP2.

FIGS. 11B and 11C show that the inner portions 23″, 23′″ and outer portions 24″, 24′″, facing the bead 12, of the bead-like distribution channels 50, 50′ may also be configured having different angles, similarly to the bead flanks 22, 22′. In this case, the distribution channel 50 is configured in the manner of a full bead, and the balcony or distribution channel 50′ is configured in the manner of a half-bead. The relevant outer portions 24″, 24′″ may be spherical but need not be. In a different approach, the distribution channels 50, 51 are regarded as fluid-guiding beads which, in relation to a macroscopic direction of extension of the bead 12, for example ignoring the wavy shape of the bead 12 in the portion shown, extend substantially in parallel with the bead 12. In cross-section perpendicular to the bead course, the mutually facing bead flanks 22, 22′, 22″, 22′″ of the sealing bead 12 and of the fluid-guiding bead have at least a first, outer portion 23, 23′, 23″, 23′″ and a second, inner portion 24, 24′, 24″, 24″, which span different positive angles to the plane (P) of the metal layer adjacent to the bead 12.

FIGS. 1-11C are shown approximately to scale. FIGS. 1-11C show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A separator plate comprising:
a metal layer having at least one bead, the at least one bead having two bead flanks, one or both bead flanks of the bead having a first portion and a second portion which have different positive angles to the plane of the metal layer adjacent to the bead, the angles in cross-section perpendicular to the bead course, and the angles formed in at least a first segment along the direction of extension of the bead.

2. The separator plate according to claim 1, wherein the first portion has an angle α and the second portion has an angle β, where α<β.

3. The separator plate according to claim 1, wherein the first portion and/or the second portion extends in a rectilinear or curved manner in the cross-section.

4. The separator plate according to claim 1, wherein the first portion extends from a bead foot towards a bead top at an increasing angle α.

5. The separator plate according to claim 4, wherein at least two beads extend at a distance from one another in a substantially parallel manner in at least one portion, and the first portions of the flanks of the two beads merge into one another at least in at least one region.

6. The separator plate according to claim 5, wherein one of the at least one beads is a sealing bead and another of the at least one beads is a fluid-guiding bead, and mutually facing bead flanks of the sealing bead and of the fluid-guiding bead each having the first portion and the second portion having the different positive angles.

7. The separator plate according to claim 1, wherein a first segment of a bead top of the bead is rectilinear or curved in cross-section perpendicular to the direction of extension of the bead.

8. The separator plate according to claim 1, wherein the bead extends in a wavy manner in its direction of extension, with at least one wave trough and at least one wave peak.

9. The separator plate according to claim 8, wherein, for at least one of the wavy beads, the bead has a first segment in at least one wave trough and/or one wave peak.

10. The separator plate according to claim 1, wherein, for at least one bead, in cross-section perpendicular to the bead course, in at least a second segment, one or both bead flanks of the bead extends at an angle γ to the plane of the metal layer adjacent to the sealing bead, the angle γ being greater than an angle δ of the at least one bead flank to the plane of the metal layer in the bead course adjacent to the second segment.

11. The separator plate according to claim 1, wherein, for at least one bead, in at least a third segment, a distance between bead feet of the bead is greater than a distance between the bead feet in a segment adjacent to the third segment.

12. The separator plate according to claim 1, wherein, for at least one bead, the bead is a sealing bead, and one or more bead-like elevations rise out of the plane of the metal layer in the same direction as the sealing bead and the one or more bead-like elevations open into the sealing bead on one of the flanks of the sealing bead.

13. The separator plate according to claim 1, wherein, for at least one bead, the bead is a fluid-guiding bead which at one end opens into the bead flank of a sealing bead that rises out of the plane of the metal layer in the same direction as the fluid-guiding bead.

14. The separator plate according to claim 1, wherein the metal layer has at least one second bead, the at least one second bead, in at least one further segment along the direction of extension of the second bead, for one or both bead flanks of the second bead, the bead foot of the second bead is spaced apart from the bead top of the second bead, in a direction perpendicular to the layer plane of the metal layer, by a distance which is greater in the middle of the further segment than the distance at the edges of the further segment.

15. The separator plate according to claim 14, wherein, in cross-section perpendicular to the bead course, one or both bead flanks of the at least one second bead have a length that increases from the edges of the further segment to the middle of the further segment.

16. The separator plate according to claim 15, wherein the gradient of the bead flank in the further segment is constant along the direction of extension of the second bead.

17. The separator plate according to claim 16, wherein the second bead is the sealing bead.

18. The separator plate according to claim 1, wherein the first portion extends from a bead foot towards a bead top in a curved manner in cross-section with a radius R1, where R1≤50 mm.
